(19) United States
(12) Patent Application Publication
(10) Pub. No.: US 2025/0125888 A1
(43) Pub. Date: Apr. 17, 2025

(54) USER EQUIPMENT AUTONOMOUS RESOURCE DETECTION FOR CALIBRATION

(71) Applicant: NOKIA TECHNOLOGIES OY, Espoo (FI)

(72) Inventors: Ali KARIMIDEHKORDI, Munich (DE); Samantha CAPORAL DEL BARRIO, Aalborg (DK); Simon SVENDSEN, Aalborg (DK)

(21) Appl. No.: 18/727,567

(22) PCT Filed: Mar. 3, 2022
(86) PCT No.: PCT/US2022/018785

§ 371 Date: Jul. 9, 2024

(51) Int. Cl. H04B 17/11; H04B 17/318; H04L 5/00; H04W 74/0833

(52) U.S. Cl. CPC H04B 17/11; H04B 17/328; H04L 5/0048; H04W 74/0833

(57) ABSTRACT

Systems, methods, apparatuses, and computer program products for user equipment autonomous resource detection for calibration are provided. For example, a method may include detecting and measuring, by a user equipment, received power during at least one synchronization signal block or channel state information reference signal. The method may also include selecting, by the user equipment, at least one random access channel occasion based on the detected and measured received power. The method may further include determining, by the user equipment, at least one random access channel occasion corresponding to the selected at least one synchronization signal block. The method may additionally include performing, by the user equipment, a user equipment calibration during the determined at least one random access channel occasion.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing user equipment autonomous resource detection for calibration.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform detecting and measuring received power during at least one synchronization signal block or channel state information reference signal. The at least one memory and computer program code can also be configured, with the at least one processor, to cause the apparatus at least to perform selecting at least one random access channel occasion based on the detected and measured received power. The selecting can be based on determining that the at least one random access channel occasion is associated to a measured and detected synchronization signal block of the at least one synchronization signal block. The at least one memory and computer program code can be configured, with the at least one processor, to cause the apparatus at least to perform performing a user equipment calibration during the determined at least one random access channel occasion.

An embodiment may be directed to an apparatus. The apparatus can include at least one processor and at least one memory comprising computer program code. The at least one memory and computer program code can be configured, with the at least one processor, to cause the apparatus at least to perform sending an activation message to a user equipment. The activation message can be configured to activate the user equipment to perform autonomous discovery and scheduling of transmissions for user equipment calibration. The at least one memory and computer program code can also be configured, with the at least one processor, to cause the apparatus at least to perform sending a de-activation or reconfiguration message to the user equipment. The de-activation or reconfiguration can be configured to de-activate or reconfigure the user equipment regarding performing the autonomous discovery and scheduling of transmissions for user equipment calibration.

An embodiment may be directed to a method. The method may include detecting and measuring, by a user equipment, received power during at least one synchronization signal block or channel state information reference signal. The method may also include selecting, by the user equipment, at least one random access channel occasion based on the detected and measured received power. The selecting can be based on determining that the at least one random access channel occasion is associated to a measured and detected synchronization signal block of the at least one synchronization signal block. The method may additionally include performing, by the user equipment, a user equipment calibration during the determined at least one random access channel occasion.

An embodiment may be directed to a method. The method may include sending, by a network element, an activation message to a user equipment. The activation message can be configured to activate the user equipment to perform autonomous discovery and scheduling of transmissions for user equipment calibration. The method may also include sending, by the network element, a de-activation or reconfiguration message to the user equipment. The de-activation can be configured to de-activate or reconfigure the user equipment regarding performing the autonomous discovery and scheduling of transmissions for user equipment calibration.

An embodiment may be directed to an apparatus. The apparatus may include means for detecting and measuring received power during at least one synchronization signal block or channel state information reference signal. The apparatus may also include means for selecting at least one random access channel occasion based on the detected and measured received power. The selecting can be based on determining that the at least one random access channel occasion is associated to a measured and detected synchronization signal block of the at least one synchronization signal block. The apparatus may additionally include means for performing a user equipment calibration during the determined at least one random access channel occasion.

An embodiment may be directed to an apparatus. The apparatus may include means for sending an activation message to a user equipment. The activation message can be configured to activate the user equipment to perform autonomous discovery and scheduling of transmissions for user equipment calibration. The apparatus may also include means for sending an activation message to a user equipment. The activation message can be configured to activate the user equipment to perform autonomous discovery and scheduling of transmissions for user equipment calibration.

### BRIEF DESCRIPTION OF THE DRAWINGS:

For proper understanding of example embodiments, reference should be made to the accompanying drawings, wherein:

FIG. 1 illustrates two examples of an UL gap distribution pattern;

FIG. 2 illustrates an example of scenario of potential interference;

FIG. 3 illustrates an example of serving beam changes for mobile users;

FIG. 4 illustrates a signaling flow chart of a method according to certain embodiments;

FIG. 5 illustrates an information element that can be used in certain embodiments;

FIG. 6 illustrates a further information element that can be used in certain embodiments;

FIG. 7 illustrates an additional information element that can be used in certain embodiments;

FIG. 8 illustrates an example of a network with sixteen synchronization signal beams;

FIG. 9 illustrates a mapping between random access occasions and synchronization signal blocks for frequency range 2;

FIG. 10 illustrates a flow diagram of a user equipment method, according to certain embodiments;

FIG. 11 illustrates UE radar transmission in which the UE performs proximity sensing from one panel, according to certain embodiments.

FIG. 12 illustrates UE radar transmission in which the UE performs proximity sensing from two panels.

FIG. 13 illustrates UE radar transmission in which the UE performs proximity sensing from all panels sequentially;

FIG. 14 illustrates UE radar transmission in which the UE performs proximity sensing from all panels simultaneously;

FIG. 15 illustrates a method according to certain embodiments;

FIG. 16 illustrates a method according to certain embodiments; and

FIG. 17 illustrates an example block diagram of a system, according to an embodiment.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing user equipment autonomous resource detection for calibration, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to a user equipment method to autonomously discover a resource usable for user equipment (UE) calibration measurement. Examples of UE calibration measurements can include transmission power calibration with radar operation to detect maximum permissible exposure events. The mechanism of certain embodiments may enhance UE calibration operations, such as radar, while limiting UL degradation like throughput loss due to uplink (UL) gap scheduling and interference generation.

One aspect of mobile device design and configuration relates to limiting exposure for the benefit of the users and to meet governmental or other exposure guidelines. Typical governmental guidelines or regulations may be aimed at preventing health issues to a user due to thermal effects on the user's body. The maximum permissible exposure (MPE) may refer to a regulation on power density for the mmWave regime. For example, the Federal Communications Commission (FCC) sets the threshold for MPE at 10 W/m2 (1 mW/cm2). For a certain distance separating human tissue from the antenna, a user equipment (UE) transmission (Tx) power back-off (PBO) can be used for FCC compliance with MPE. The PBO can throttle transmit power of UEs that are in power limitation or close to it, for example cell edge UEs, non-line-of-sight (NLOS) scenarios, or the like. Such PBO can reduce the power received by the next generation Node B (gNB) and may consequently also reduce the uplink signal to interference and noise ratio (SINR) as well, potentially causing UL failures.

There can be power management maximum power reduction (P-MPR) reporting to mitigate UL degradation due to MPE events. The MPE reports can be performed by re-using the P and R bits of a power headroom report (PHR) when an MPE event is triggered at the UE by setting P-bit to 1 and providing a P-MPR indication with 2 R bits of the PHR. MPE P-MPR reporting is specified in Third Generation Partnership Project (3GPP) technical specification (TS) 38.306, which can provide a non-limiting context. In that specification, the reporting is an optional UE capability.

In order to detect MPE on a UE, the UE may use various techniques to become aware of, for example, body proximity. Some devices can be equipped with proximity sensors, such as infrared sensors, capacitive sensors, radar technology, or the like. One option for proximity sensors for UE mmW implementation is to embed a radar functionality on the mmW arrays, in order to optimize space and design, as well as to reduce cost and complexity of the front-end of the UE.

In order to perform the radar measurement with the mmW array elements in a periodic way without missing UL transmissions and without disturbing neighboring UEs, the UE may be configured with UL gaps.

UL gaps in frequency range 2 (FR2) may be used for MPE purpose, for example, for UE Tx power management. The UL gaps in FR2 may also be used for coherent UL multiple input multiple output (MIMO) purposes. For example, there may be UE-specific network configured gaps for general self-calibration and monitoring purposes including UE Tx power management and coherent UL MIMO.

The UL gaps for these purposes may be explicitly activated by the network (NW) via signaling and may also be explicitly deactivated by the NW via signaling. The UE may explicitly or implicitly indicate to the NW that the gap activation is needed, and the UE may explicitly or implicitly indicate to the NW that the gap deactivation is needed. An example of implicit indication can include P-MPR reporting. The NW can also, or alternatively, activate such gaps without UE indication and deactivate such gaps without UE indication.

The UL gap for such purposes can be configured and activated/deactivated directly by, for example, radio resource control (RRC) signaling. As another option, the UL gap can be explicitly configured by RRC signaling but can be activated and deactivated by a medium access control (MAC) control element (CE).

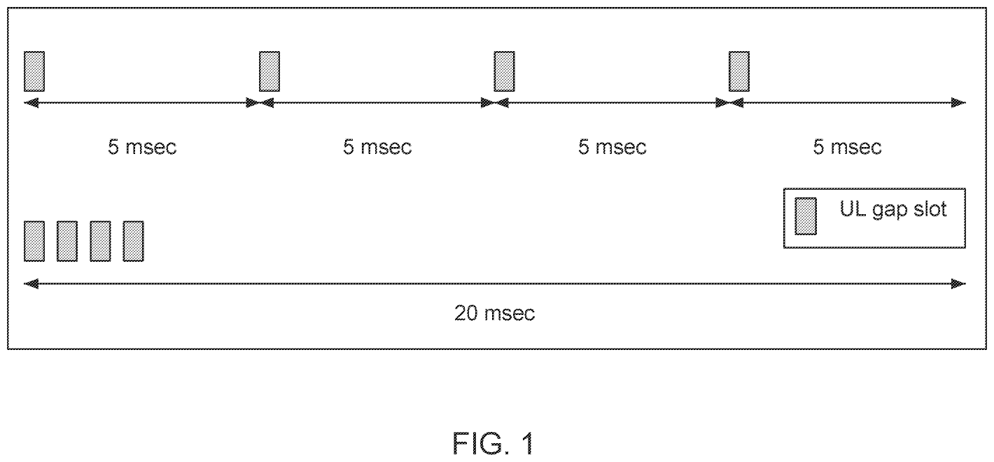

FIG. 1 illustrates two examples of an UL gap distribution pattern. The network may schedule the UL-gap during UL slots, and may support flexible configurations to accommodate different user panel/radio frequency (RF) implementations. More particularly, FIG. 1 illustrates two examples of an UL gap distribution pattern for a scenario with 120 kHz SCS, with a 0.125 microsecond (usec) slot, assuming 0.5 millisecond (msec) UL-gap length (UGL) and 20 msec uplink gap repetition periodicity (UGRP), such that there is 2.5% UL overhead.

The UL gap length and periodicity may be based on the device RF requirements and imposed UL overhead. There can be at least four gap configurations (numbered #0, #1, #2 and #3 for convenience and ease of reference only, and not by way of limitation, preference, or priority). ULGP #0 may have 1.0 msec UGL, 20 msec UGRP, and 5% UL overhead. ULGP #1 may have 1.0 msec UGL, 40 msec UGRP, and 2.5% UL overhead. ULGP #2 may have 0.5 msec UGL, 160 msec UGRP, and ˜0.31% UL overhead. ULGP #3 may have 0.125 msec UGL, 5 msec UGRP, and 2.5% UL overhead.

Therefore, certain embodiments may relate to UL opportunities for a UE to perform self-calibration and monitoring without disturbing other UEs, for example without providing unnecessary interference to other UEs. Radar for MPE or coherent UL MIMO internal calibration are examples of the self-calibration and monitoring tasks that the UL opportunities may be used for.

Certain embodiments may focus on a radar use case particularly. This use case, however, may be just an example. The same principles and procedures may be applied or extended to other types of UE internal calibration, as mentioned above or as otherwise desired.

The UEs considered by certain embodiments may be, for example, UEs using radar as a body proximity sensing technique. Such radar technique may be performed in-band or out-of-band. Certain embodiments may be applicable, for example, to in-band radar application. At 28 GHZ, the available bandwidth is up to 400 MHZ, which may be limited for accurate radar estimation. Beyond 71 GHz may have a greater availability bandwidth. However, the specific frequencies and bands mentioned are just some examples.

In certain embodiments the UE may detect random access channel (RACH) opportunities for such measurements autonomously, without the need for network indication, hence reduce signaling overhead for enabling radar operation on unused RACH opportunities.

The approach described herein may be suitable for use together with a network-controlled approach. The network may in some scenarios, for example in a loaded cell, keep control of each UE's radar operation and at other times, for example when a UE has high mobility, enable UEs to autonomously detect opportunities to perform radar operation under some thresholds.

In addition to optimizing the proximity sensor performance for MPE by providing predictable gap patterns, one aspect of UL gap configuration design may be to avoid degrading SINR of UL transmissions of neighboring UEs' transmissions from the potential interference caused by UE transmitting, for example, radar signals to evaluate body proximity. This avoiding of degradation may be valid for serving cell as well as neighboring cells. Synchronization signal (SS) bursts can be synchronized across cells.

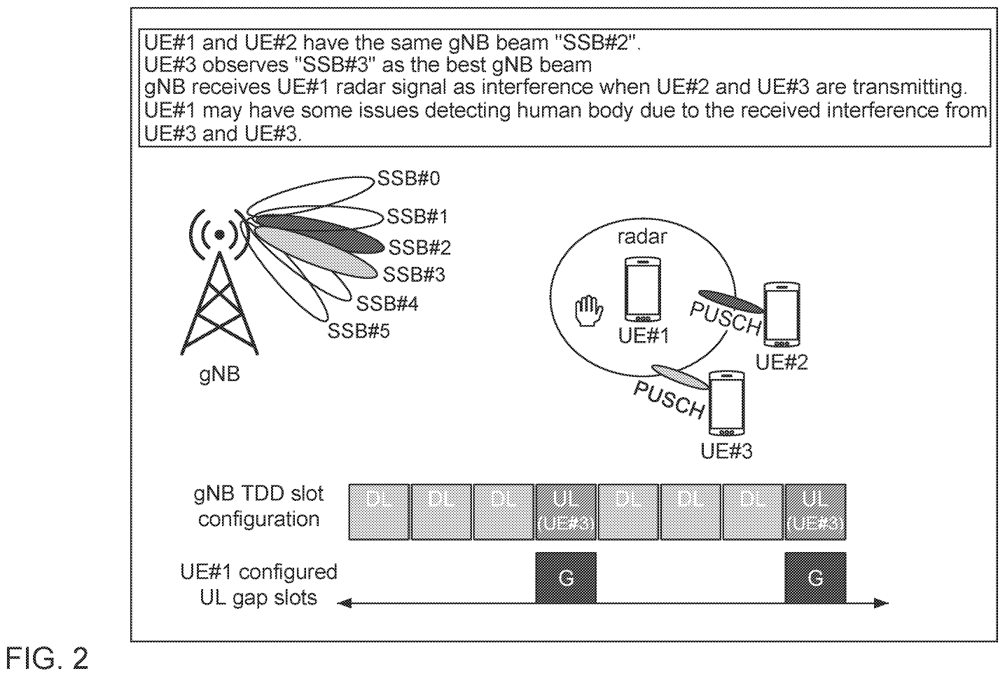

FIG. 2 illustrates an example of scenario of potential interference. In FIG. 2, the gNB has configured UE #1 with UL gap slots, while UE #2 and UE #3 have been scheduled to transmit PUSCH at the same times and towards the same gNB beam, for example SSB #3 and SSB #2. UE #1 radar signals may create interference over UE #2 and UE #3 physical uplink shared channel (PUSCH) transmissions. As can be seen, since the UEs are in the same area, they share same gNB beam, and thus UE #1 radar signals can act as an interferer to both UE #2 and UE #3 UL transmissions. Thus, the received PUSCH signal qualities may decrease, leading to network/user throughput and/or reliability performance degradation. Moreover, the PUSCH transmission of UE #2 and UE #3 may interfere with the UE #1 radar signals and hence could decrease the accuracy of the body proximity sensors.

The potential exists for at least two considerations: transmission of UE radar signals during UL gap slot may cause interference over neighboring UEs, and UL gap scheduling may yield a significant UL throughput degradation due to less UL transmission slots for PUSCH.

Thus, for example, transmission of UE radar signals during UL gap slot may cause interference over neighboring UEs, for example for in-band radar utilizing a large bandwidth. Furthermore, a limitation of UL gap configuration may be that the gap may then be applied for all UEs of a given gNB beam, whether the other UEs need such a gap or not, because of potential interference caused during this slot for in-band radar.

Additionally, UL gap scheduling may reduce the UL throughput of the UE. A range of 0.25%-5% UL gap overhead may be employed, for example. The UL gap overhead may be defined as the duration of UL gap over its periodicity. For FR2 in numerology 3, SCS=120 kHz and 1 subframe there may be 8 slots in 1 ms. Therefore, the UL gap periodicity of 0.25% corresponds to 1 slot every 400 slots, which means 1 slot every 50 ms. Similarly, the UL gap periodicity of 5% corresponds to 1 slots/20 slots, which means 1 slots per 2.5 ms.

For example, considering a frame structure DDDSU in FR2 numerology 3, with 120 kHz SCS, there can be 4 UL slots in 2.5 ms. Thus, there may be 1.25% less UL scheduling opportunities with a 0.25% UL gap periodicity. Moreover, there may be 25% less UL scheduling opportunities with 5% UL gap periodicity.

For a UE that has positive gain from using UL gaps, such a UE, when allocated UL gaps, may in fact not have any negative impact on UL throughput (TP) from having UL gaps allocated due to not applying UL Tx power back off. The UE with positive gain from using UL games may be a UE that would apply power back off if not allocated with UL gaps while power back off would actually not be needed.

For a UE that may have a negative impact from not being allocated UL gaps, such a UE would apply power back off on UL transmission even if this would actually not be needed. Hence, such a UE could have negative UL TP impact from not being allocated UL gaps.

The 25% reduction in scheduling opportunities may be considered a significant reduction in UL scheduling opportunities. Nonetheless, when the UL gap reveals that there is no user, MPE power back-off may not be applied and the UE may transmit with significantly higher power, for example with about 3-4 dB increase of Tx power. Thus, in case there is no nearby user and consequently no need for such power backoff, UL TP may be improved due to the greater power gain.

As mentioned above, UL gap scheduling may yield a significant UL throughput degradation due to less UL transmission slots for PUSCH, as they may be replaced by UL gaps. Thus, the issue may not be compensated for in case the UE cannot increase its Tx power, for example when an MPE event is actually detected.

Therefore, certain embodiments provide a robust solution to address UE need for body proximity detection to enhance UE Tx power, for example MPE calibration, while minimizing UL throughput degradation due to UL gap scheduling and while avoiding the interference to other legacy UL transmissions.

As mentioned above, in high mobility scenarios and/or to limit signaling, the gNB may permit autonomous UE behavior to discover such SSB random access channel (RACH) occasions (ROs). This may lead to the UE reporting the discovered ROs or may lead to the UE directly performing radar measurements using the discovered ROs.

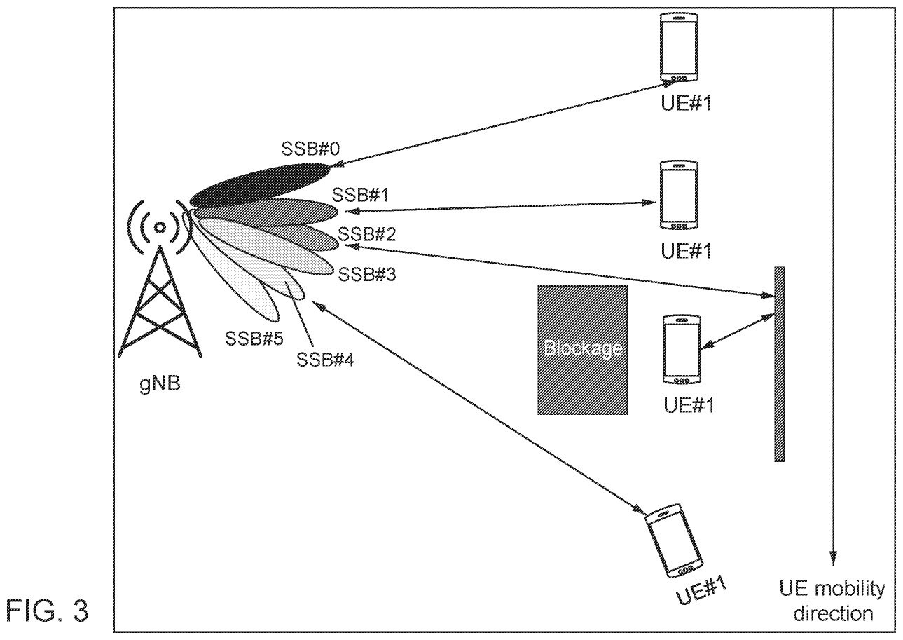

FIG. 3 illustrates an example of serving beam changes for mobile users. As exemplified in FIG. 3, a UE may change beam often, hence the indices of non- detected SSB beams also vary often. For example, when UE #1 is connected to SSB #0, it may receive SSB #4 and SSB #5 below a sensitivity threshold and such beams may be good candidates for performing UE radar operation. However, when UE #1 moves and is connected to SSB #4, the situation may be the opposite. In addition, with blockage and multi-panel UEs, the SSB indices that can be usable for performing radar may vary frequently in high mobility scenarios. Hence, network control may require high overhead.

With high mobility and/or UE rotations, the SSB indices where the radar measurement are possible without interfering with other UEs may change rapidly and frequently, and network-controlled operation may require additional signaling.

Certain embodiments may optimize UE Tx power by enabling body proximity sensing for MPE estimation while avoid UL throughput loss due to the scheduling of UL gaps. Such may provide a gNB/UE mechanism for radar signal transmission. More particularly, certain embodiments may adapt well with UE desired proximity sensor periodicity/length. Furthermore, certain embodiments may create low interference over other synchronous UL transmissions. Additionally, certain embodiments may receive low interference from the other synchronous UL transmissions. Moreover, certain embodiments may have low computational complexity to determine the configuration. Also, certain embodiments may be robust against dynamic variations the network load and activation of different gNB beams. Certain embodiments may provide benefits from low overhead configuration/reconfiguration. Moreover, certain embodiments may be flexible and simple to reconfigure, activate, and deactivate.

The UE may be able to send a desired gap pattern, for example UL gap lengths and periodicity to the gNB based on its implementation. The desired gap pattern may be provided as part of UE capability. The network may then be the entity responsible determining the configuration and sending the configuration to the UE.

Certain embodiments provide a method to discover RACH occasions where to perform UE UL calibration without causing interference to serving and neighboring transmission/reception points (TRPs). Certain embodiments may avoid or reduce the need for UL gap scheduling for such UE UL calibration tasks.

The UE UL calibration can be, for example, UE Tx power management to comply with MPE regulation(s). MPE event detection can rely on body proximity sensing done with a radar embedded in the UE antenna array. Certain embodiments avoid the need for UL gap scheduling by instead utilizing RACH occasions. Thus, UL throughput can be maintained, as UL gap scheduling would otherwise reduce PUSCH opportunities.

In certain embodiments, the UE can measure SSBs in an SS burst, both from the serving gNB and also from neighboring gNBs, and can determine non-detected SSB indices. Non-detected SSB indices can refer to each index value where no power was detected or where power was detected but the power measured below a certain RSRP/SINR threshold. Then, based on the measurement, for example the measured RSRP value of each panel, the UE can autonomously select a subset of non-detected SSBs including SSBs measured below a certain RSRP/SINR threshold. The UE can decode or otherwise determine RACH occasions for each SSB of the subset. The UE can perform radar proximity sensing on the respective random access occasions slots from the corresponding panel. In certain embodiments, the RSRP/SINR threshold may be network configured, specified, or up to UE implementation. The procedure of using RACH occasions of non-detected SSBs for radar operation may be activated or allowed and de-activated or forbidden by the network.

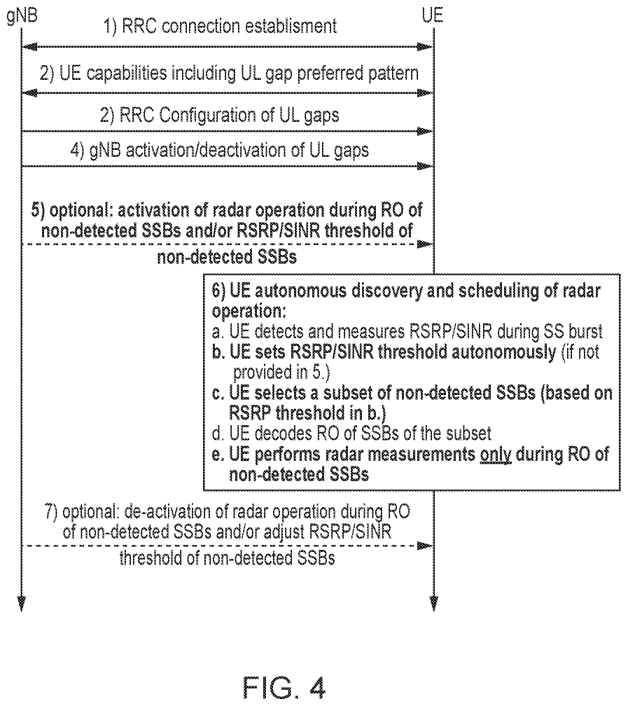

FIG. 4 illustrates a signaling flow chart of a method according to certain embodiments. As shown in FIG. 4, at procedure 1, the UE and the gNB can establish the connection, for example, through Msg. 1 to Msg. 4 transmissions. At 2, the UE can indicate the UE's preferred UL gaps pattern configurations to the network based on the UE's implementation, for example as part of UE capabilities. Then, the gNB can configure, at 3, and activates/deactivate, at 4, UL gaps based on UL traffic status, channel quality, and the like.

AT 5, the network may indicate to the UE or allow the UE to use RO slots for calibration transmission. For example, calibration transmission may be MPE radar signals. Moreover, the gNB may indicate an RSRP/SINR threshold to select SSBs usable for radar operation without causing interference.

At 6, autonomous discovery and scheduling of radar operation can be performed. Procedure 6 can involve a variety of subprocedures. At a, the UE can measure all SSBs in the SS burst, both from the serving gNB and from potential neighboring gNBs. At b, if the serving gNB does not indicate the RSRP/SINR threshold, the UE may autonomously choose the RSRP value to select the SSBs of which the RO is usable for radar operation. For the RSRP threshold, the UE could use the already configured rsrp-ThresholdSSB value that was provided to the UE through RACH-ConfigCommon configurations, as described by Third Generation Partnership Project (3GPP) technical specification (TS) 38.331. The UE could use an offset value with respect to rsrp-ThresholdSSB. The UE could, as a further option, use the UE's sensitivity level and the RSRP threshold. As another option, the UE can configure a new threshold.

At c, the UE can categorize SSBs of the SS burst into above/below RSRP/SINR threshold, this can also be described as detected/non detected SSBs, in order to identify which ones of the SSBs have a RO that can be used for radar measurements. The UE can select a subset of SSBs measured below a RSRP/SINR threshold to be used for radar.

At d, beyond the SSB indices, the UE can identify each RO of the corresponding SSB by decoding broadcasted signals, for example system information block (SIB). At e, if the UE detects from multiple gNBs that the same SSB index is below the threshold at the same SSB time instance, or index, and detected on the same UE panel, the UE can determine whether the SSBs have a common RO slot(s) in time, namely a same RACH configuration index. At f, the UE can transmit radar signals over corresponding RO slots on the selected SSB subset.

At 7, the network may reactivate the UE for UL gaps scheduled during UL slots and may indicate to the UE not to perform calibrating radar measurements during RO any longer, for example in case of high interference, loaded cell, or the like. The network may also adjust the RSRP threshold to reduce the chances of interference.

As can be seen from the above examples, the UE can autonomously detect RACH opportunities of SSBs where the UE can perform radar measurements without causing interference. This detection can involve autonomously estimating the non-detected SSBs. The SSBs may be deemed non-detected when RSRP and/or SINR are received below a threshold or not detected at all. The detection can also involve decoding or otherwise determining their associated RACH opportunities through an SSB that is well received, for example RSRP and/or SINR above a threshold. This may be possible because each SSB may contain the info for all SSBs of the SS burst. Certain embodiments may be applicable to serving cell reporting as well as to neighboring cells. Neighbor cell measurements may be reported to the serving cell.

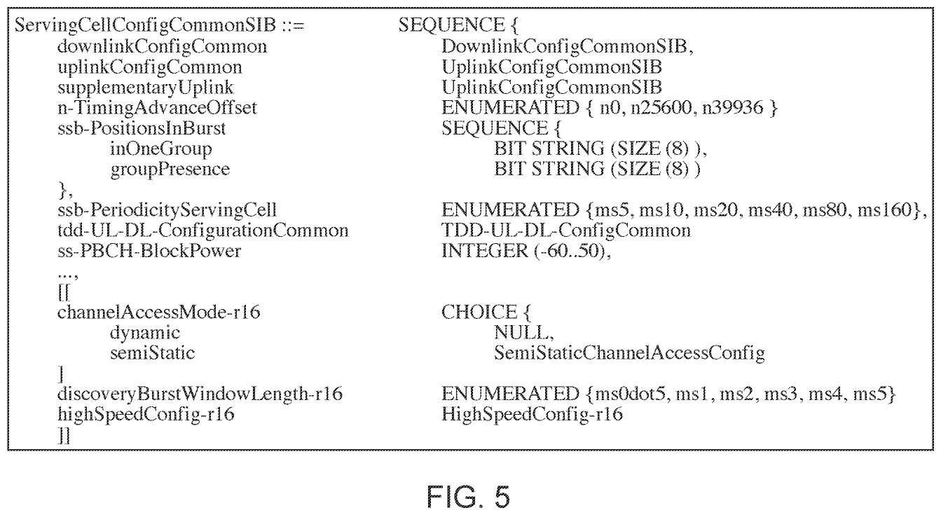

FIG. 5 illustrates an information element that can be used in certain embodiments. The details of SSB transmission can be provided to the UE through SIB1 content. As presented in FIG. 5, the information element (IE) ServingCellConfigCommonSIB can include configurations of cell specific parameters of the UE's serving cell in SIB1. Parameter ssb-PositionsInBurst can indicate the time domain positions of the transmitted SS-blocks in an SS-burst. Transmission of up to 64 SSBs may be supported in new radio (NR) frequency range 2 (FR2). Moreover, SS burst periodicity and the time division duplex (TDD) configurations can be provided by ssb-PeriodicityServingCell and tdd-UL-DL-ConfigurationCommon, respectively.

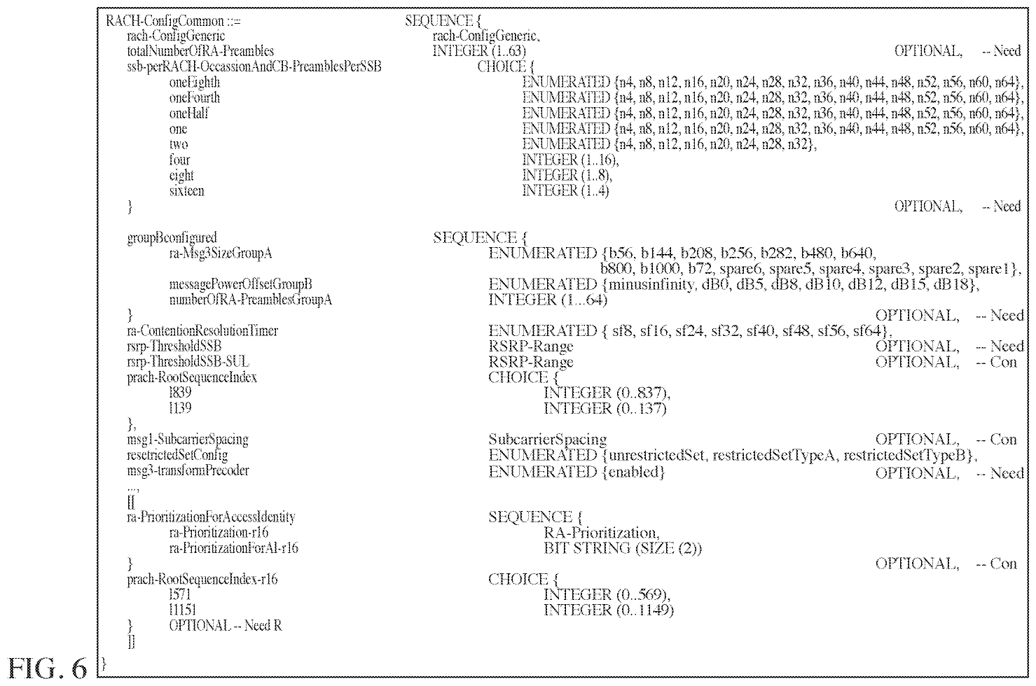

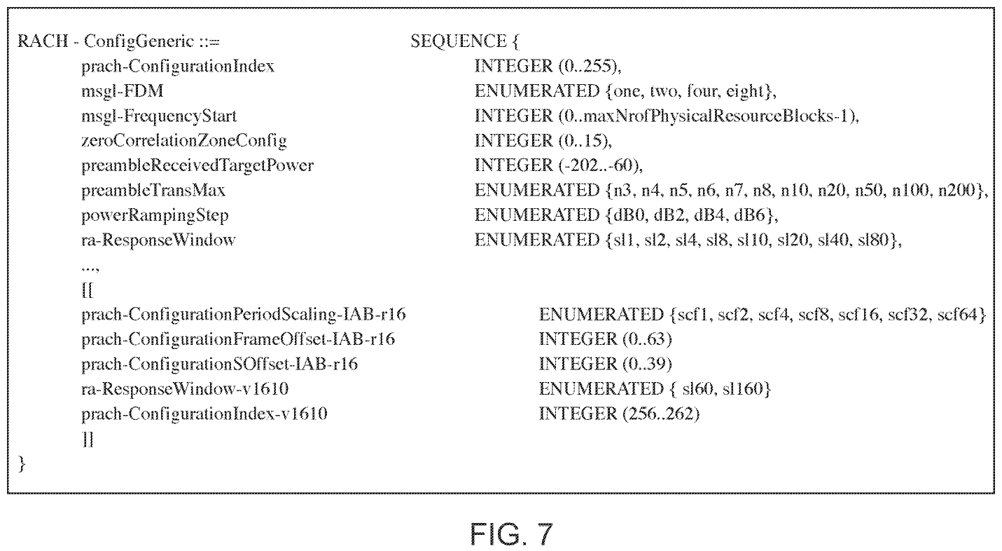

FIGS. 6 and 7 illustrate more information elements that can be used in certain embodiments. As presented in FIGS. 6 and 7, IEs RACH-ConfigCommon and RACH-ConfigGeneric can be used to specify the cell specific random-access parameters for both initial access and beam failure recovery. From these configurations, the UE could identify the ROs of both detected or measured and non-detected or not measured SSBs. The IEs of FIGS. 5, 6, and 7 are described by 3GPP TS 38.331.

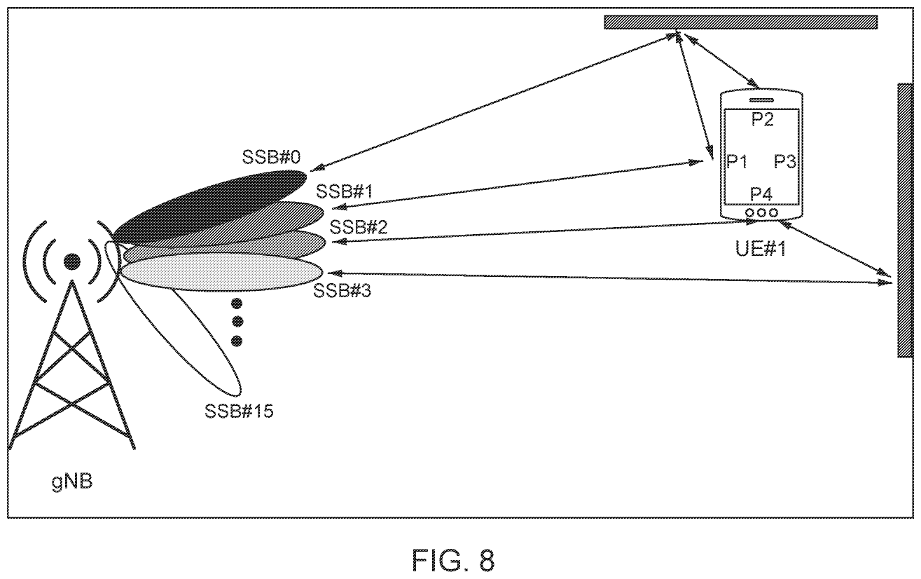

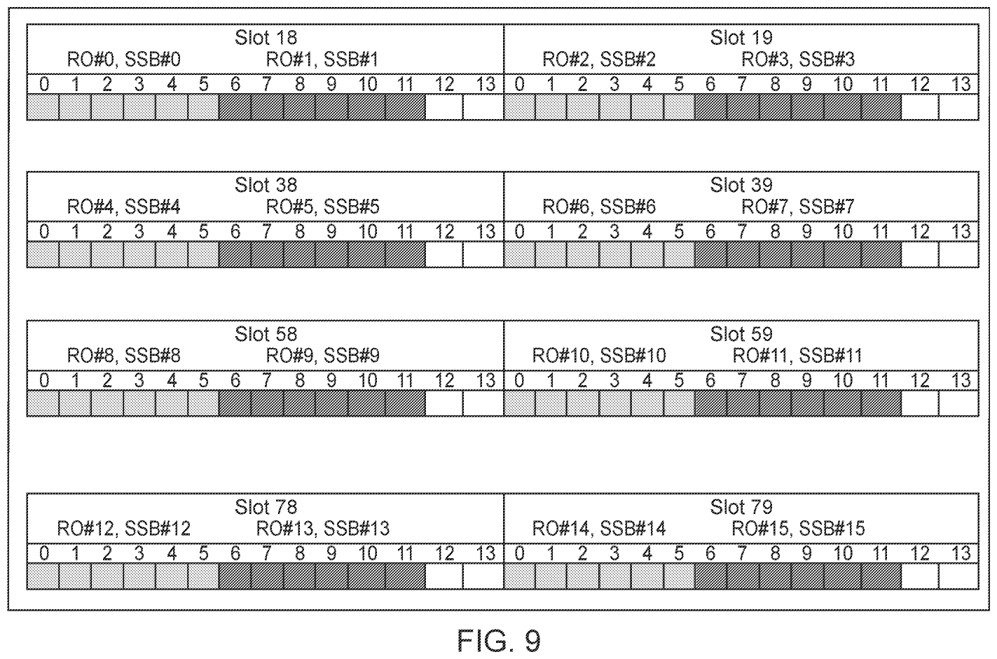

FIG. 8 illustrates an example of a network with sixteen synchronization signal beams. In the example with 16 beams at the serving gNB, as presented in FIG. 8, UE #1 has four panels of antennas, respectively P1, P2, P3, and P4. In this illustration, P3 does not receive any of the beams, P4 receives the beam associated with SSB #2 directly and the beam associated with SSB #3 via a reflection. P1 receives SSB #1 directly and SSB #1 via a reflection. P2 only receives SSB #0 via a reflection. In this example, the network may use PRACH index 76 for RO configuration of all of the SSBs of the burst, as detailed below and in FIG. 9.

For PRACH configuration index 76 the preamble format may be A3. The NSFN mod x=y values for x and y may be 1 and 0, respectively. Slot numbers 9, 19, 29, and 39 may correspond, and a starting symbol may be 0. The number of PRACH slots within a 60 kHz slot may be 2. The number of TD PRACH occasions within a PRACH slot may be 2. The PRACH duration may be 6.

According to symbol location described for 60 kHz above, the RACH transmission symbol can be calculated for 120 kHz slot. As such, for Config Index 76, RO in slot 9 in 60 kHz corresponds in 120 kHz to RO in slot 18, starting at symbol 0 for a duration of 6 symbols, in slot 18 starting at symbol 6 for a duration of 6 symbols, in slot 19 starting at symbol 0 for a duration of 6 symbols, and in slot 19 starting at symbol 6 for a duration of 6 symbols. Next, a similar mapping may be calculated for slot 19, 29, and 39 in 60 kHz to 120 kHz.

FIG. 9 illustrates a mapping between random access occasions and synchronization signal blocks for frequency range 2. Based on the provided configuration, the RACH transmission symbols for 120 kHz subcarrier spacing are symbols 0 and 6 in slots 18, 19, 38, 39, 58, 59, 78 and 79. Assuming msg1-FDM=one (in the configuration shown in FIG. 7), and ssb-perRACH-OccasionAndCB-PreamblesPerSSB=one (in the configuration shown in FIG. 6), RACH occasions in TD and associated SSB beam IDs can be illustrated as presented in FIG. 9. Each SSB of the burst has a unique RO: they can all be calculated from the configuration index, as detailed above. Thus, FIG. 9, illustrates a mapping between ROs and SSBs for FR2, assuming PRACH Config. Index=76, SCS=120 kHz, msg1-FDM=one, and ssb-perRACH-OccasionAndCB-PreamblesPerSSB=one.

Returning to the example shown in FIG. 8, the four panel UE may be able to detect SSB #0,1 from panel #1, SSB #0 from panel #2, no SSB from panel #3, and SSB #2 and SSB #3 from panel #4.

Based on the performed measurement, the UE could not detect, or the UE measured RSRP below a threshold, SSB #4-15 from any of the UE's panels, hence the UE can use ROs of SSB #4-15, for example slots 38, 39, 58, 59, 78, and 79, for MPE radar. Furthermore, in this example each panel observes a different subset of the SS burst such that the UE can associate potential ROs for radar per panel. For example, in case of radar transmission from panel #1, RO of SSB #2-3 in slot #19 could be used for radar measurement from panel 1. The above example can be expanded to include SSBs and ROs from neighboring gNBs.

The RO associated to non-detected SSBs can be calculated from the detected SSBs as described above. The UE may require multiple slots, for example 4 out of 8 available slots, in order to perform a reliable radar measurement. Such details may be left to UE implementation.

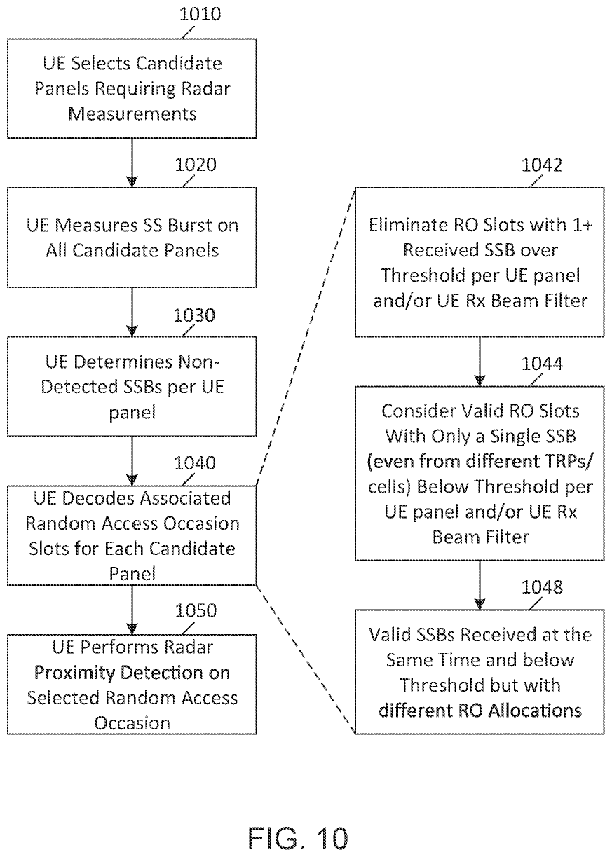

FIG. 10 illustrates a flow diagram of a user equipment method, according to certain embodiments. Optionally, although not explicitly shown in FIG. 10, the UE may receive SSB-based radar configurations from the network. This configuration can include RSRP threshold and/or max number of permitted slots for performing radar, disallowed RO slots, or the like.

At 1010, in FIG. 10, the UE can determine the panels from which body proximity sensing need to be performed. In a fixed UE, which receives high signal quality from the UE's top panel, the UE may decide to perform radar only on that specific panel. In a moving UE described in FIG. 8, the UE may decide to perform radar on panels #1, 2, and 4, because the UE does not expect to transmit data from panel #3 based on the performed measurements. Based on the application in use and the way the device is being held, the UE may predict most used panels for radar. A rotating UE may decide to do radar sensing from all panels.

At 1020, the UE may perform SSB measurement of both serving gNB and neighboring gNBs from the panels that were selected to do radar sensing. At 1030, the UE can determine or otherwise identify the non-detected SSBs, where the power is not measured at all or measured below a threshold.

At 1040, based on the user capability and performed measurements, the UE can selects a sub-set of non-measured RO slots for radar transmission. The valid RO slots can be determined by the following sub-steps. At 1042, RO slots where at least a single corresponding SSB is received above the threshold per UE panel or per UE spatial reception (Rx) beam filter can be considered not a valid candidate RO for radar application. At 1044, the RO slots where only a single corresponding SSB is received below the threshold can be considered a valid candidate RO for radar application. RO slots where the multiple corresponding SSBs are received below the threshold can be considered a valid candidate RO for radar application. More generally, at 1044, the UE can consider as valid any RO lots with all SSB (even from different TRPs or different cells) below a threshold per UE panel and/or per UE spatial Rx beam filter. At 1048, SSBs received at the same time instance and below the threshold, but with different RO slot allocations, for example when different TRPs have different RACH configurations, can be considered a valid candidate RO for radar application. For example, if the UE has one or more RO in which to perform calibration, then this can be considered valid.

In addition to RSRP of the serving cell, the UE may take into account the received power level from neighboring cells and select a RO in which the neighboring gNBs also receive low interference from radar signals. This approach may be applicable for network with synchronous gNBs.

At 1050, the UE can perform radar proximity sensing over the selected RO slots.

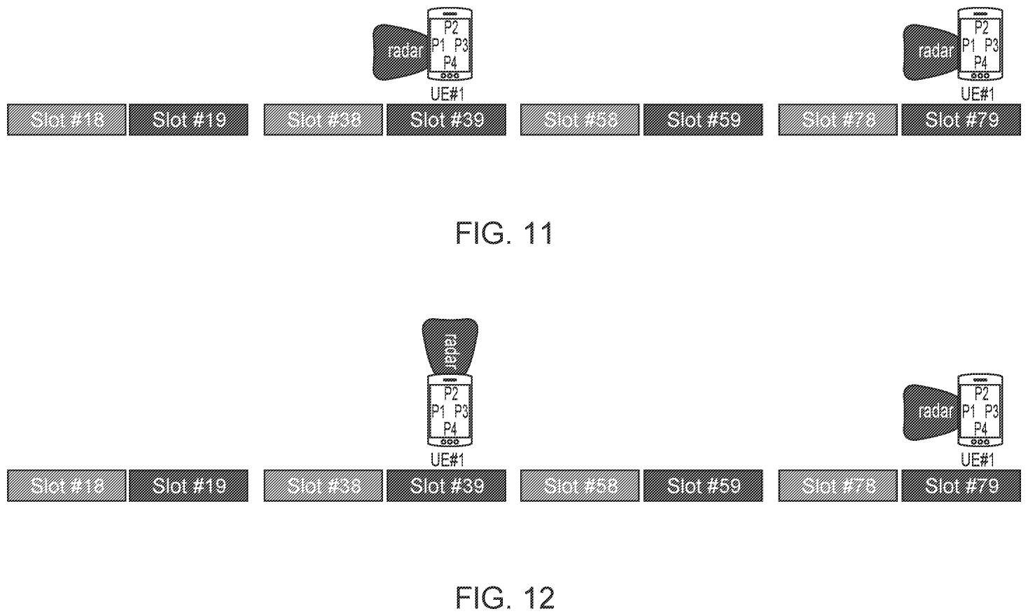

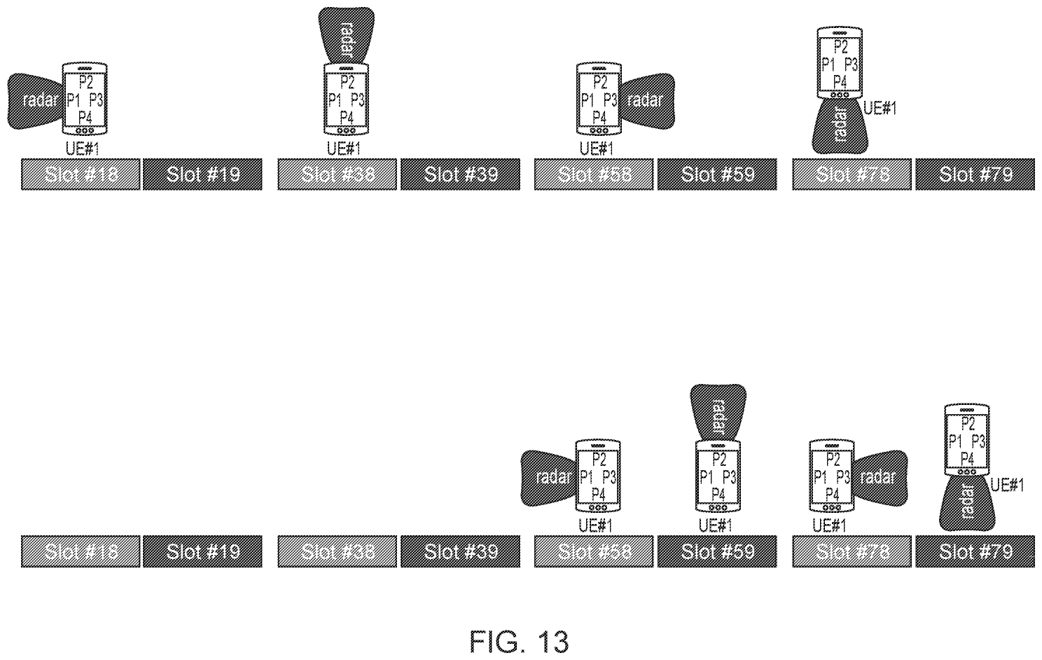

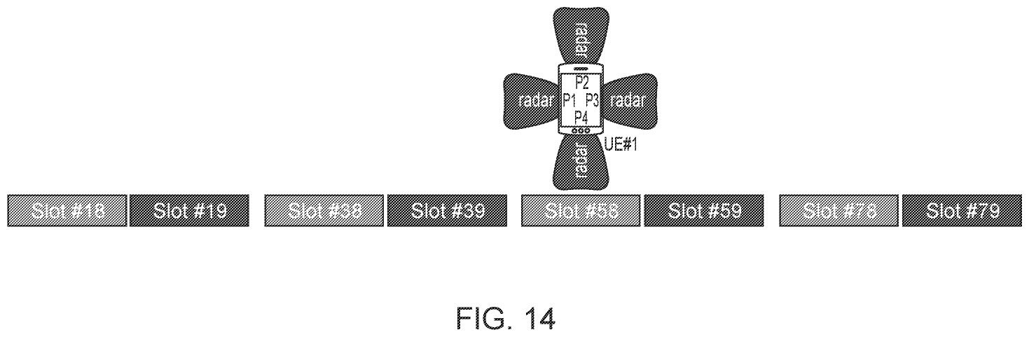

FIGS. 11-14 provide some examples of the UE radar proximity sensing signal transmissions. They illustrate the UE behavior of autonomous radar after having detected non-interfering RO slots. FIG. 11 illustrates UE radar transmission in which the UE performs proximity sensing from panel #1 . FIG. 12 illustrates UE radar transmission in which the UE performs proximity sensing from panel #1 and panel #2 . FIG. 13 illustrates UE radar transmission in which the UE performs proximity sensing from all panels sequentially. FIG. 14 illustrates UE radar transmission in which the UE performs proximity sensing from all panels simultaneously.

Certain embodiments relate to user equipment (UE) autonomous resource detection for calibration. More particularly, certain embodiments relate to how a user equipment can identify random access channel (RACH) occasions (ROs) where the UE can perform UE uplink (UL) calibration without causing interference to neighboring transmission-reception points (TRPs). Such identification of ROs by the UE can avoid the need for UL gap scheduling.

In certain embodiments, a process can begin with a radio resource control (RRC) connection establishment between a next generation Node B (gNB) and a UE. The UE may provide to the network an identification of UE capabilities including, for example, an UL gap pattern that is preferred by the user equipment.

The gNB can configure UL gaps to the UE and can activate and deactivate those gaps. Additionally, the network can indicate or otherwise allow the UE to use RO slots for calibration transmission, such as sending maximum permissible exposure (MPE) radar signals.

The gNB may, in certain embodiments, indicate a reference signal received power (RSRP) and/or signal to interference plus noise ratio (SINR) threshold to select synchronization signal blocks (SSBs) usable for radar operation without causing interference.

Certain embodiments may have the benefit of permitting UE autonomous discovery and scheduling of radar operation. Moreover, features like the threshold(s) provided by the gNB may ensure that the UE operates in a way that is appropriate for a given cell taking into account neighboring TRPs, broadly including other UEs and serving and neighboring gNBs.

In certain embodiments, the UE can measure all SSBs in a synchronization signal (SS) burst, both from the serving gNB and from potential neighboring gNBs. If the serving gNB does not indicate the RSRP/SINR threshold, the UE may autonomously choose an RSRP value to select the SSBs of which the RO is usable for radar operation. As a further option, a default RSRP value may be configured to the UE.

For the RSRP threshold, the UE may use an already configured RSRP-thresholdssb value. The RSRP-thresholdssb value may be provided to the UE through RACH-configcommon configurations, described in Third Generation Partnership Project (3GPP) technical specification (TS) 38.331. As another option, the UE may use an offset value with respect to RSRP-thresholdSSB, a sensitivity level, and the RSRP threshold. As a further option the UE may configure a new threshold.

The UE can categorize SSBs of the SS burst into above/below RSRP/SINR threshold. For example, the categories can include detected/non detected SSBs. The categorization may be performed in order to identify which SSBs have a RO that can be used for radar measurements.

The UE can select a subset of SSBs measured below RSRP/SINR threshold to be used for radar. Beyond the SSB indices, the UE can identify each RO of the corresponding SSB by decoding broadcasted signals, for example system information block (SIB).

If the UE detects from multiple gNBs that the same SSB index is below the threshold at the same SSB time instance and detected on the same UE panel, the UE can determine that the SSBs have common RO slots in time, for example, that the SSBs have a same RACH configuration index. The SSB time instance can correspond to an SSB index.

The UE can transmit radar signals over corresponding RO slots on the selected SSB subset. The radar signals can be used to perform MPE detection.

Certain embodiments may relate to de-activation of radar operation during RO of non-detected SSBs and/or adjustment of a RSRP/SINR threshold of non-detected SSBs. Such de-activation and/or adjustment may be performed autonomously or by the command of the network. For example, a gNB may send a deactivation message or may send an update to a previously provided threshold.

Based on the performed measurement, if the UE could not detect, or if the UE measured RSRP below a threshold, certain SSBs (for example, SSB #4 -15) from any of the UE's panels, the UE can ROs of those SSBs for MPE radar. In this example of SSB #4 -15, the slots used for MPE radar may be slots 38, 39, 58, 59, 78, and 79.

In certain embodiments, each panel may only observe a subset of the SS burst, such that the UE can associate potential ROs for radar per panel.

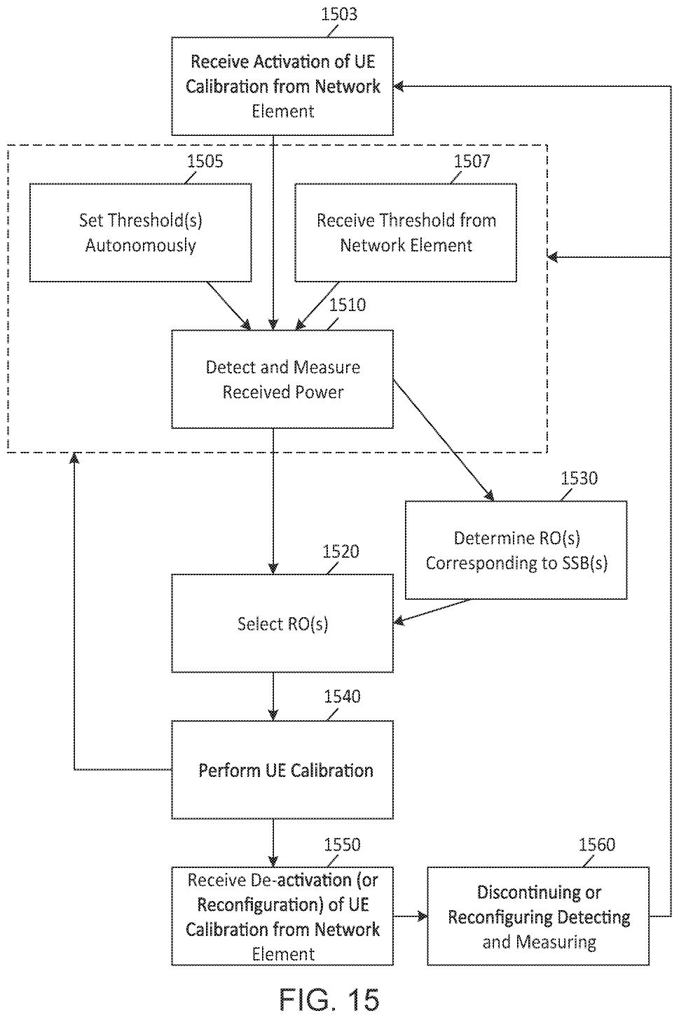

FIG. 15 illustrates an example flow diagram of a method for providing user equipment autonomous resource detection for calibration, according to certain embodiments. The method of FIG. 15 can be implemented by a signal flow such as shown in FIGS. 4 and 10.

The method of FIG. 15 may include, at 1510, detecting and measuring received power during at least one synchronization signal block or channel state information reference signal. The method can also include, at 1520, selecting at least one random access channel occasion based on the detected and measured received power. The selecting, at 1520, can be based on determining, at 1530, that the at least one random access channel occasion is associated to, or otherwise corresponds with, a measured and detected synchronization signal block of the at least one synchronization signal block.

Thus, the method can further include, at 1530, determining at least one random access channel occasion corresponding to at least one synchronization signal block, based on the detection and measurements and 1510. In certain cases, the detection and measurements can lead to a selection of a most suitable SSB based on the detections/measurements and then an RO corresponding to that SSB can be determined and selected. The method can additionally include, at 1540, performing a user equipment calibration during the determined at least one random access channel occasion, for example, only during the determined at least one random access channel occasion. During the determined at least one random access channel occasion can include during the entirety of, or part of, one or more random access occasion(s) or during an entirety of, or part of, one or more random access occasion slot(s). After performing the calibration, the UE can revert to any of 1505, 1507, or 1510, and the process can continue.

The detecting and measuring received power at 1510 can include detecting and measuring at least one of a reference signal received power or signal to interference plus noise ratio. The detecting and measuring can be performed during a synchronization signal burst or channel state information reference signal transmission.

The selecting the at least one synchronization signal block at 1520 based on the detected and measured received power can include comparing the detected and measured received power to a threshold. For example, there can be a threshold RSRP and/or a threshold SINR value to which the measured power can be compared. This measurement can be a serving cell measurement and/or a neighboring cell measurement, including a measurement of one or more neighboring cells.

The method can also include, at 1505, setting the threshold autonomously by the user equipment. As mentioned above, the UE can set its own threshold(s) for RSRP and SINR in a variety of ways, including directly re-using a threshold that is used for another purpose or re-using a threshold modified by a certain amount.

The method can further include, at 1507, receiving the threshold from a network element, such as a gNB. This threshold may be configured with an activation message or separately form the activation message, if an activation message is used, as described below.

At 1503, the method can include receiving activation of the user equipment calibration from a network element, wherein the detecting and measuring is performed based on the activation. Receiving activation can include receiving an activation message generated by the network element, which may be a gNB.

The method can also include, at 1550, receiving de-activation or reconfiguration of the user equipment calibration from a network element. The method can further include, at 1560, discontinuing or reconfiguring the detecting and measuring based on the de-activation or reconfiguration. In the case of deactivation, the method can return to 1503 when a new activation is received. In the case of reconfiguration, the method can return to any of 1505, 1507, or 1510.

The user equipment calibration can include performing radar measurements. The performing radar measurements comprises determining proximity of a human user of the apparatus. These may be measurements for MPE purposes, as described above.

The detecting and measuring received power at 1510 can include further steps, such as those illustrated in FIG. 10. For example, the method can include selecting at least one panel of antennas from a plurality of panels or at least one spatial reception beam filter. The detecting and measuring the received power at 1510 can include measuring a synchronization signal burst on the at least one panel of antennas. The method can also include determining at least one synchronization signal block as not detected based on the measuring. As mentioned above, not detected can encompass both a case where no power is received for the synchronization signal block and a case where power is received, but it is received below a threshold.

The method can include decoding or otherwise determining random access occasion slots for each panel of the at least one panel. The method can include eliminating random access occasion slots with one or more synchronization signal block received over a threshold per user equipment panel or spatial reception beam. The determining at least one random access channel occasion can include the eliminating prior to a final selection of the at least one random access channel occasion.

Similarly, the method can include considering as valid for selection random access occasion slots with only a single synchronization signal block detected below a threshold per user equipment panel or spatial reception beam. The consideration of the random access occasion slots can be performed prior to a final selection of the at least one random access channel occasion.

The method can further include considering as valid for selection random access occasion slots with a plurality of synchronization signal blocks detected below a threshold. The consideration of the random access occasion slots can be performed prior to a final selection of the at least one random access channel occasion.

The method can also include considering valid synchronization signal blocks received at a same time and below a threshold but with different random access occasion allocations. The determining at least one random access channel occasion can include the considering valid prior to a final selection of the at least one random access channel occasion.

It is noted that FIG. 15 is provided as one example embodiment of a method or process. However, certain embodiments are not limited to this example, and further examples are possible as discussed elsewhere herein.

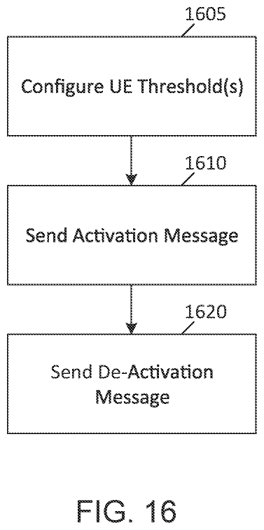

FIG. 16 illustrates an example flow diagram of a method for providing user equipment autonomous resource detection for calibration, according to certain embodiments. The method of FIG. 16 can be used alone or in combination with the method of FIG. 15. The methods of FIGS. 15 and 16 can be implemented by a signal flow such as shown in FIG. 4.

The method can include, at 1610, sending an activation message to a user equipment. The activation message can be configured to activate the user equipment to perform autonomous discovery and scheduling of transmissions for user equipment calibration. The method can further include, at 1620, sending a de- activation or reconfiguration message to the user equipment. The de-activation can be configured to de-activate the user equipment from performing the autonomous discovery and scheduling of transmissions for user equipment calibration. The reconfiguration can be configured to modify the user equipment with respect to performing the autonomous discovery and scheduling of transmissions for user equipment calibration.

The user equipment calibration can include performing radar measurements. The performing radar measurements can include determining proximity of a human user of the user equipment.

The method can also include, at 1605, configuring the user equipment with at least one threshold for performing the autonomous discovery and scheduling of transmissions for user equipment calibration. This configuring is shown separately from the activation message, but may be provided with the activation message. The activation message and the deactivation message may be triggered by other determinations, not shown. For example, a gNB may determine that the user equipment has the capability of performing such autonomous discovery and scheduling of transmissions, and accordingly, may activate such features from time to time, assuming that no adverse impact on network operations is expected. Likewise, in case an adverse impact on network operations is expected or experienced, the de-activation or reconfiguration message can be triggered.

It is noted that FIG. 16 is provided as one example embodiment of a method or process. However, certain embodiments are not limited to this example, and further examples are possible as discussed elsewhere herein.

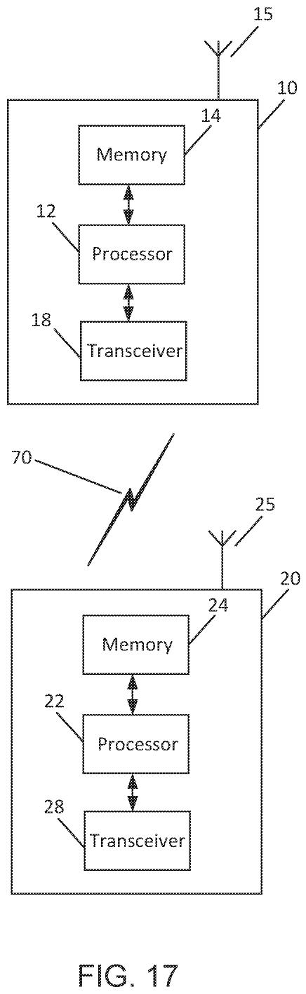

FIG. 17 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 17.

As illustrated in the example of FIG. 17, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 17, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 4, 10, 15, and 16, or any other method described herein. In some embodiments, as discussed herein, apparatus 10 may be configured to perform a procedure relating to providing user equipment autonomous resource detection for calibration, for example.

FIG. 17 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 17.

As illustrated in the example of FIG. 17, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 17, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 4, 10, 15, and 16, or any other method described herein. For example, in an embodiment, apparatus 20 may be controlled to perform a process relating to providing user equipment autonomous resource detection for calibration, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, because gNBs can apply the same spatial filter, or beam, during the RO as that of the corresponding transmitted SSB, channel reciprocity holds and the UE radar transmission during RO of non-detected SSBs will not interfere the serving or the neighboring gNB when they are receiving preambles from other UEs trying to access the network. In other words, this type of UE scheduling for UE calibration, for example radar signals for MPE, may not create additional interference/contention over other synchronous UL transmissions or initial access attempts from other UEs to the same gNB. Because the UE does not generally transmit data during RO of non-detected SSBs, because the gNB is TDD and the current receive beam is pointing toward a different location, performing radar signal may have no impact on the UE throughput. There may be a low probability of UE radar signal being interfered from another UE transmitting in the same slot, because of physical distance between UEs served by different gNB beams, which may help preserve the accuracy of body proximity radar measurements. Furthermore, UE autonomous operation may reduce or remove gNB signaling overhead. In certain embodiments, there may be no need for gNB RRC reconfiguration with high user mobility, such as frequent beam switching and subset of usable SSB updates. Certain embodiments may incur no or a low additional power consumption at the UE, because the UE is already monitoring SSB of the serving and neighboring gNBs for inter and intra beam management. In certain embodiments, the UE may categorize the RO slots into valid candidates for radar application. SSB/RO configurations can have similar periodicity as that of required by UE for radar proximity sensing. Moreover, SSB/RO positions can fixed, periodic and do not much change with load variations in the network. This may allow the UE to timely/reliably perform radar proximity sensing.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

AC Access
AGC Automatic Gain Control
CSI-RS Channel State Information Reference Signal
DL Downlink
DMRS Demodulation Reference Signal
gNB Next Generation Node-B
MPE Maximum Permissible Exposure
NR 5G New Radio
PA Power Amplifier
PDCCH Physical Downlink Control Channel
PDCP Packet Data Convergence Protocol
PDSCH Physical Downlink Shared Channel
RA Random Access
RACH Random Access Channel
RO Random Access Occasion
RRC Radio Resource Control
RSRP Reference Signal Received Power
SRS Sounding Reference Signal
SSB Synchronization Signal Block
SSBRI SSB Resource Block Indicators
SSS Secondary Synchronization Signal
TDD Time Division Duplexing
UE User Equipment
UL Uplink
WB Wide Beam

1. An apparatus, comprising:
at least one processor; and
at least one memory comprising computer program instructions,
wherein the at least one memory and the computer program instructions are configured to, with the at least one processor, cause the apparatus at least to perform:
detecting and measuring received power during at least one synchronization signal block or channel state information reference signal;
selecting at least one random access channel occasion based on the detected and measured received power, wherein the selecting is based on determining that the at least one random access channel occasion is associated to a measured and detected synchronization signal block of the at least one synchronization signal block; and
performing a user equipment calibration during the determined at least one random access channel occasion.

2. The apparatus of claim 1, wherein the detecting and measuring received power comprises detecting and measuring at least one of a reference signal received power or signal to interference plus noise ratio.

3. The apparatus of claim 1, wherein the detecting and measuring is performed during a synchronization signal burst or channel state information reference signal transmission.

4. The apparatus of claim 1, wherein the selecting the at least one random access channel occasion based on the detected and measured received power comprises comparing the detected and measured received power to a threshold.

5. The apparatus of claim 4, wherein the at least one memory and the computer program instructions are configured to, with the at least one processor, cause the apparatus at least to perform:
setting the threshold autonomously.

6. The apparatus of claim 4, wherein the at least one memory and the computer program instructions are configured to, with the at least one processor, cause the apparatus at least to perform:
receiving the threshold from a network element.

7. The apparatus of claim 1, wherein the at least one memory and the computer program instructions are configured to, with the at least one processor, cause the apparatus at least to perform:
receiving activation of the user equipment calibration from a network element, wherein the detecting and measuring is performed based on the activation.

8. The apparatus of claim 1, wherein the at least one memory and the computer program instructions are configured to, with the at least one processor, cause the apparatus at least to perform:
receiving de-activation or reconfiguration of the user equipment calibration from a network element; and
discontinuing or reconfiguring the detecting and measuring based on the de-activation or reconfiguration.

9. The apparatus of claim 1, wherein the user equipment calibration comprises performing radar measurements.

10. The apparatus of claim 9, wherein the performing radar measurements comprises determining proximity of a human user of the apparatus.

11. The apparatus of claim 1, wherein the at least one memory and the computer program instructions are configured to, with the at least one processor, cause the apparatus at least to perform:
selecting at least one panel of antennas from a plurality of panels or at least one spatial reception beam filter, wherein the detecting and measuring the received power comprises measuring a synchronization signal burst on the at least one panel of antennas;
determining at least one synchronization signal block as not detected based on the measuring.

12. The apparatus of claim 11, wherein the at least one memory and the computer program instructions are configured to, with the at least one processor, cause the apparatus at least to perform:
determining random access occasion slots for each panel of the at least one panel.

13. The apparatus of claim 11, wherein the at least one memory and the computer program instructions are configured to, with the at least one processor, cause the apparatus at least to perform:
eliminating random access occasion slots with one or more synchronization signal block received over a threshold per user equipment panel or spatial reception beam, wherein the determining at least one random access channel occasion comprises the eliminating prior to a final selection of the at least one random access channel occasion.

14. The apparatus of claim 11, wherein the at least one memory and the computer program instructions are configured to, with the at least one processor, cause the apparatus at least to perform:
considering as valid for selection random access occasion slots with only a single synchronization signal block detected below a threshold per user equipment panel or spatial reception beam, wherein the consideration of the random access occasion slots is performed prior to a final selection of the at least one random access channel occasion.

15. The apparatus of claim 11, wherein the at least one memory and the computer program instructions are configured to, with the at least one processor, cause the apparatus at least to perform:
considering as valid for selection random access occasion slots with a plurality of synchronization signal blocks detected below a threshold, wherein the consideration of the random access occasion slots is performed prior to a final selection of the at least one random access channel occasion.

16. The apparatus of claim 11, wherein the at least one memory and the computer program instructions are configured to, with the at least one processor, cause the apparatus at least to perform:
considering valid synchronization signal blocks received at a same time and below a threshold but with different random access occasion allocations, wherein the determining at least one random access channel occasion comprises the considering valid prior to a final selection of the at least one random access channel occasion.

17. An apparatus, comprising:
at least one processor; and
at least one memory comprising computer program instructions,
wherein the at least one memory and the computer program instructions are configured to, with the at least one processor, cause the apparatus at least to perform:
sending an activation message to a user equipment, wherein the activation message is configured to activate the user equipment to perform autonomous discovery and scheduling of transmissions for user equipment calibration; and
sending a de-activation or reconfiguration message to the user equipment, wherein the de-activation or reconfiguration is configured to de-activate or reconfigure the user equipment regarding performing the autonomous discovery and scheduling of transmissions for user equipment calibration,
wherein the autonomous discovery and scheduling for user equipment calibration comprises determining that at least one random access channel occasion is associated to a measured and detected synchronization signal block.

18.-20. (canceled)

21. A method, comprising:
detecting and measuring, at a user equipment, received power during at least one synchronization signal block or channel state information reference signal;
selecting, by the user equipment, at least one random access channel occasion based on the detected and measured received power, wherein the selecting is based on determining that the at least one random access channel occasion is associated to a measured and detected synchronization signal block of the at least one synchronization signal block; and
performing, by the user equipment, a user equipment calibration during the determined at least one random access channel occasion.

22.-60. (canceled)

61. A non-transitory computer-readable medium encoded with instructions that, when executed in hardware, perform the method according to claim 21.

62. (canceled)
